(19) United States
(12) Patent Application Publication
(10) Pub. No.: US 2017/0242555 A1
(43) Pub. Date: Aug. 24, 2017

(54) USER INTERFACE COMPONENT FOR BROWSING INDUSTRIAL ASSETS

(71) Applicant: General Electric Company, Schenectady, NY (US)

(72) Inventors: Martin Wragg, Walnut Creek, CA (US); Carlos Hernandez, San Ramon, CA (US)

(21) Appl. No.: 15/261,153

(22) Filed: Sep. 9, 2016

Related U.S. Application Data
(60) Provisional application No. 62/297,629, filed on Feb. 19, 2016.

(51) Int. Cl. G06F 3/0482; H04L 29/08

(52) U.S. Cl. CPC G06F 3/0482; H04L 67/10; H04L 67/18

(57) ABSTRACT

In example embodiments, a method of implementing an industrial asset browser user interface is disclosed. An asset browser component is embedded in a user interface of an application executing on a device. A notification is received at the asset browser component pertaining to activation in a dashboard user interface of an asset in an industrial internet of things (IIoT). Information that is to be presented by the asset browser component in response to the notification is updated. An asset browser user interface is opened for presentation of the updated information. Upon a closing of the asset browser user interface, a breadcrumb presented in the dashboard user interface is updated to reflect an interaction of the user with the asset browser user interface.

### CROSS-REFERENCE TO RELATED APPLICATIONS

This application claims the benefit of U.S. Provisional Application No. 62/297,629, filed Feb. 19, 2016, which is incorporated by reference herein in its entirety.

### TECHNICAL FIELD

This application relates generally to graphical user interfaces and, in one specific example, to a graphical user interface component for browsing assets in an Industrial Internet of Things (IIoT) and programmatically incorporating the user interface component into an application design.

### BACKGROUND

The traditional Internet of Things (IoT) involves the connection of various consumer devices, such as coffee pots and alarm clocks, to the Internet to allow for various levels of control and automation of those devices. The Industrial Internet of Things (IIoT), on the other hand, involves connecting industrial assets as opposed to consumer devices. There are technical challenges involved in interconnecting diverse industrial assets, such as wind turbines, jet engines, and locomotives, that do not exist in the realm of consumer devices.

### BRIEF DESCRIPTION OF DRAWINGS

The present disclosure is illustrated by way of example and not limitation in the figures of the accompanying drawings, in which like references indicate similar elements and in which:

FIG. 1 is a block diagram illustrating a system, in accordance with an example embodiment, implementing an IIoT.

FIG. 2 is a block diagram illustrating different edge connectivity options that an IIoT machine provides, in accordance with an example embodiment.

FIG. 3 is an example method of implementing an industrial asset browser component in an application.

FIG. 4 is a line drawing depicting an example user interface of a dashboard card of an application executing on a device of a user.

FIG. 5 is a line drawing depicting an example user interface of an asset browser user interface suitable for presentation on a wide display.

FIG. 6 is a line drawing depicting an example user interface of an additional asset browser user interface.

FIG. 7 is a line drawing depicting an example user interface of an additional asset browser user interface that is suitable for presentation on a mobile device.

FIG. 8 is a line drawing depicting an example user interface of an additional asset browser user interface that is suitable for presentation on a mobile device.

FIG. 9 is an example of a direct context that may be received via an application program interface (API) of the asset browser component or from other components or programming logic included in a card containing the asset browser component.

FIG. 10 is an example of an initial context that may be received via an API of the asset browser.

FIG. 11 is an example API for programmatically accessing or controlling an asset browser component that is included in a user interface.

FIG. 12 is a block diagram illustrating a representative software architecture which may be used in conjunction with various hardware architectures herein described.

FIG. 13 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes illustrative systems, methods, techniques, instruction sequences, and machine-readable media (e.g., computing machine program products) that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Some of the technical challenges involved in an IIoT include items such as predictive maintenance, where industrial assets can be serviced prior to problems developing to reduce unplanned downtimes. As such, one such technical challenge involves prediction of when industrial assets or parts thereon will fail. In an example embodiment, an IIoT may be designed that monitors data collected from sensors and, using physics-based analytics, detects potential error conditions based on an asset model. The asset in question can then be gracefully shut down for maintenance at the appropriate time. In addition to these types of edge applications (applications involving the industrial assets directly), the IIoT may also pass the sensor data to a cloud environment where operational data for all similar machines under management can be stored and analyzed. Over time, data scientists can discover new patterns and create new and improved physics-based analytical models. The new analytical model can then be pushed back to all of the assets, effectively improving the performance of all assets simultaneously.

In example embodiments, a method of implementing an industrial asset browser user interface is disclosed. An asset browser component (or widget) is embedded in a user interface of an application executing on a device. A notification is received at the asset browser component pertaining to activation in a dashboard user interface of an asset in an IIoT. Information that is to be presented by the asset browser component in response to the notification is updated. An asset browser user interface is opened for presentation of the updated information. Upon a closing of the asset browser user interface, a breadcrumb presented in the dashboard user interface is updated to reflect an interaction of the user with the asset browser user interface.

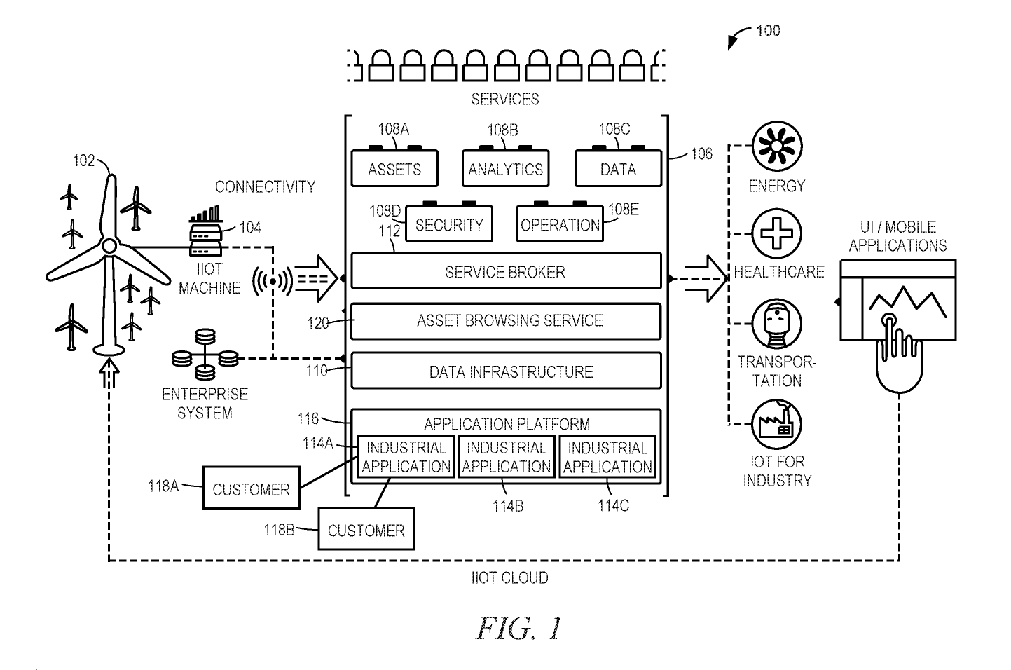

FIG. 1 is a block diagram illustrating a system 100, in accordance with an example embodiment, implementing an IIoT. An industrial asset 102, such as a wind turbine as depicted here, may be directly connected to an IIoT machine 104. The IIoT machine 104 is a software stack that can be embedded into hardware devices such as industrial control systems or network gateways. The software stack may include its own software development kit (SDK). The SDK includes functions that enable developers to leverage the core features described below.

One responsibility of the IIoT machine 104 is to provide secure, bi-directional cloud connectivity to, and management of, industrial assets, while also enabling applications (analytical and operational services) at the edge of the IIoT. The latter permits the delivery of near-real-time processing in controlled environments. Thus, the IIoT machine 104 connects to an IIoT cloud 106, which includes various modules, including asset module 108A, analytics module 108B, data module 108C, security module 108D, and operations module 108E, as well as data infrastructure 110. This allows other computing devices, such as client computers, running user interfaces/mobile applications to perform various analyses of either the individual industrial asset 102 or assets of the same type.

The IIoT machine 104 also provides security, authentication, and governance services for endpoint devices. This allows security profiles to be audited and managed centrally across devices, ensuring that assets are connected, controlled, and managed in a safe and secure manner, and that critical data is protected.

In example embodiments, a service broker 112 may deliver various services, including asset services 108A, analytics services 108B, data services 108C, security services 108D, operational services 108E, connectivity services, platform services, infrastructure services, and so on. The connectivity services may provide a managed, secure, end-to-end connectivity solution from the edge of a customer's network to the IIoT cloud. Such connectivity services may include providing physical connectivity globally (e.g., via cellular, fixed, or satellite networks), a secure virtual private network (VPN) between edge assets and the IIoT cloud to help ensure data privacy and asset protection, an ability to manage and control edge assets by providing remove access (e.g., via VNC, RDP, SSH, and HTTP), end-to-end monitoring and notifications about the connectivity between the IIT cloud and edge assets, one-stop-shop billing and reporting for all connectivity and IP services, and a self-management portal.

An application platform 116 supports the building of responsive web, mobile, and embedded applications that scale gracefully from smart phone to desktop. The user interface system provides developers and designers with simple, modular, cohesive solutions for theming, layout, and UI components with tailored integration points into the rest of the platform stack. Applications, such as industrial applications 114A-114C, are not only context-aware, but also context-adaptive, meaning they will chance according to the context, so users can visualize and interface with the application in a way that is relevant to them. This paradigm removes the need for multiple applications and context switching by users.

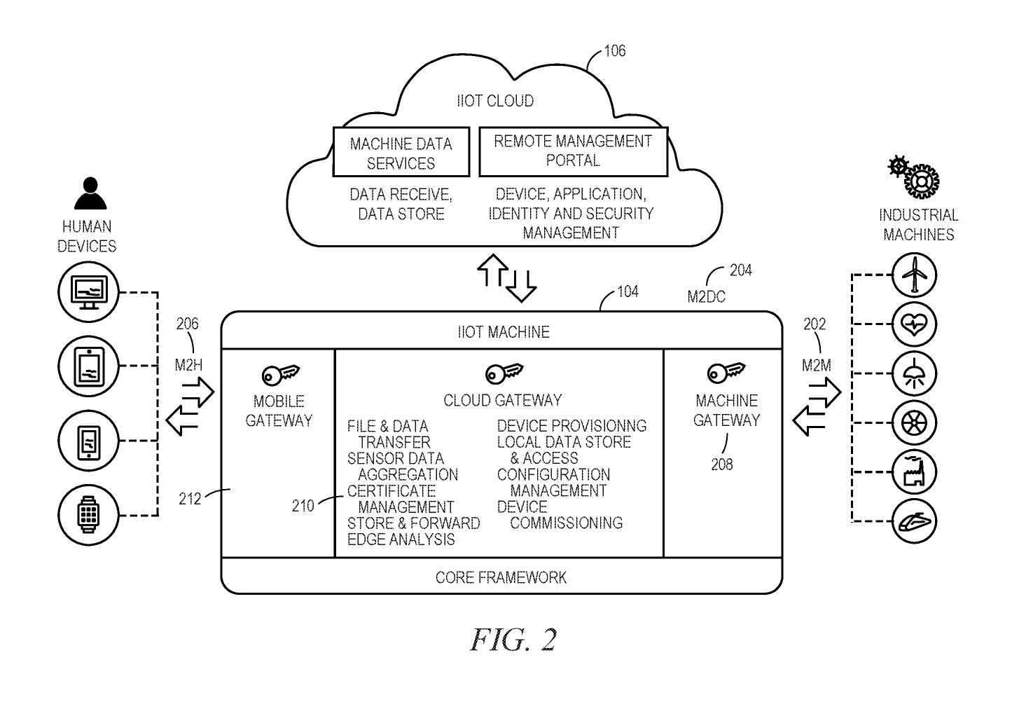

In order to meet requirements for industrial connectivity, the IIoT machine 104 can support gateway solutions that connect multiple edge components via various industry standard protocols. FIG. 2 is a block diagram illustrating different edge connectivity options that an IIoT machine 104 provides, in accordance with an example embodiment. There are generally three types of edge connectivity options that an IIoT machine 104 provides: machine gateway (M2M) 202, cloud gateway (M2DC) 204, and mobile gateway (M2H) 206.

Many assets may already support connectivity through industrial protocols such as Open Platform Communication (OPC)-UA or ModBus. A machine gateway component 208 may provide an extensible plug-in framework that enables connectivity to assets via M2M 202 based on these common industrial protocols.

A cloud gateway component 210 connects an IIoT machine 104 to an IIoT cloud 106 via M2DC 204.

A mobile gateway component 212 enables people to bypass the IIoT cloud 106 and establish a direct connection to an asset 102. This may be especially important for maintenance scenarios. When service technicians are deployed to maintain or repair machines, they can connect directly from their machine to understand the asset's operating conditions and perform troubleshooting. In certain industrial environments, where connectivity can be challenging, the ability to bypass the cloud and create this direct connection to the asset may be important.

As described above, there are a series of core capabilities provided by the IIoT system 100. Industrial scale data, which can be massive and is often generated continuously, cannot always be efficiently transferred to the cloud for processing, unlike data from consumer devices. Edge analytics provide a way to preprocess the data so that only the pertinent information is sent to the cloud. Various core capabilities provided include file and data transfer, store and forward, local data store and access, sensor data aggregation, edge analytics, certificate management, device provisioning, device decommissioning, and configuration management.

As described above, the IIoT machine 104 can be deployed in various different ways. These include on a gateway, on controllers, or on sensor nodes. The gateway acts as a smart conduit between the IIoT cloud 106 and the asset(s) 102. The IIoT machine 104 may be deployed on the gateway device to provide connectivity to asset(s) 102 via a variety of protocols.

The IIoT machine 104 can be deployed directly onto machine controller units. This decouples the machine software from the machine hardware, allowing connectivity, upgradability, cross-compatibility, remote access, and remote control. It also enables industrial and commercial assets that have traditionally operated standalone or in very isolated networks to be connected directly to the IIoT cloud 106 for data collection and live analytics.

The IIoT machine 104 can be deployed on sensor nodes. In this scenario, the intelligence lives in the IIoT cloud 106 and simple, low-cost sensors can be deployed on or near the asset(s) 102. The sensors collect machine and environmental data and then backhaul this data to the IIoT cloud 106 (directly or through an IIoT gateway), where it is stored, analyzed, and visualized.

Customers or other users may create applications to operate in the IIoT cloud 106. While the applications reside in the IIoT cloud 106, they may rely partially on the local IIoT machines 104 to provide the capabilities to gather sensor data, process it locally, and then push it to the IIoT cloud 106.

The IIoT cloud 106 enables the IIoT by providing a scalable cloud infrastructure that serves as a basis for platform-as-a-service (PaaS), which is what developers use to create Industrial Internet applications for use in the IIoT cloud 106.

Referring back to FIG. 1, services provided by the IIoT cloud 106 and generally available to applications designed by developers include asset services from asset module 108A, analytics services from analytics module 108B, data services from data module 108C, application security services from security module 108D, and operational services from operations module 108E.

Asset services include services to create, import, and organize asset models and their associated business rules. Data services include services to ingest, clean, merge, and ultimately store data in the appropriate storage technology so that it can be made available to applications in the manner most suitable to their use case.

Analytics services include services to create, catalog, and orchestrate analytics that will serve as the basis for applications to create insights about industrial assets. Application security services include services to meet end-to-end security requirements, including those related to authentication and authorization.

Operational services enable application developers to manage the lifecycle and commercialization of their applications. Operational services may include development operational services, which are services to develop and deploy Industrial Internet applications in the cloud, as well as business operational services, which are services that enable transparency into the usage of Industrial Internet applications so that developers can ensure profitability.

The asset model may be the centerpiece of many, if not all, Industrial Internet applications. While assets are the instantiations of asset types (types of industrial equipment, such as turbines), the asset model is a digital representation of the asset's structure. In an example embodiment, the asset service provides Application Program Interfaces (APIs), such as Representational State Transfer (REST) APIs that enable application developers to create and store asset models that define asset properties, as well as relationships between assets and other modeling elements. Application developers can then leverage the service to store asset-instance data. For example, an application developer can create an asset model that describes the logical component structure of all turbines in a wind farm and then create instances of that model to represent each individual turbine. Developers can also create custom modeling objects to meet their own unique domain needs.

In an example embodiment, the asset module 108A may include an API layer, a query engine, and a graph database. The API layer acts to translate data for storage and query in the graph database. The query engine enables developers to use a standardized language, such as Graph Expression Language (GEL), to retrieve data about any object or property of any object in the asset service data store. The graph database stores the data.

An asset model represents the information that application developers store about assets, how assets are organized, and how they are related. Application developers can use the asset module 108A APIs to define a consistent asset model and a hierarchical structure for the data. Each piece of physical equipment may then be represented by an asset instance. Assets can be organized by classification and by any number of custom modeling objects. For example, an organization can use a location object to store data about where its pumps are manufactured, and then use a manufacturer object to store data about specific pump suppliers. It can also use several classifications of pumps to define pump types, assign multiple attributes, such as Brass or Steel, to each classification, and associate multiple meters, such as Flow or Pressure, to a classification.

Data services from the data module 108C enable Industrial Internet application developers to bring data into the IIoT system 100 and make it available for their applications. This data may be ingested via an ingestion pipeline that allows for the data to be cleansed, merged with data from other data sources, and stored in the appropriate type of data store, whether it be a time series data store for sensor data, a Binary Large Object (BLOB) store for medical images, or a relational database management system (RDBMS).

Since many of the assets are industrial in nature, much of the data that will commonly be brought into the IIoT system 100 for analysis is sensor data from industrial assets. In an example embodiment, a time series service may provide a query-efficient columnar storage format optimized for time series data. As the continuous stream of information flows from sensors and needs to be analyzed based on the time aspect, the arrival time of each stream can be maintained and indexed in this storage format for faster queries. The time series service also may provide the ability to efficiently ingest massive amounts of data based on extensible data models. The time series service capabilities address operational challenges posed by the volume, velocity, and variety of IIoT data, such as efficient storage of time series data, indexing of data for quick retrieval, high availability, horizontal scalability, and data point precision.

The application security services provided by the security module 108D include user account and authentication (UAA) and access control. The UAA service provides a mechanism for applications to authenticate users by setting up a UAA zone. An application developer can bind the application to the UAA service and then use services such as basic login and logout support for the application, without needing to recode these services for each application. Access control may be provided as a policy-drive authorization service that enables applications to create access restrictions to resources based on a number of criteria.

Thus, a situation arises where application developers wishing to create industrial applications for use in the IIoT may wish to use common services that many such industrial applications may use, such as a log-in page, time series management, data storage, and the like. The way a developer can utilize such services is by instantiating instances of the services and then having their applications consume those instances. Typically, many services may be so instantiated.

A service may communicate (e.g., via a specific API) with a user interface component. For example, a component may be created with a specific API that talks to a service. The component may have its own generic API and generic data format. In this case, an adapter or transformer may be used by the UI component to transform the service data format and protocol and API into something that the component can communicate with. These adapters can themselves be components or attached reusable behaviors. The services and component may be included in or provided as part of a user interface (UI) platform, such as General Electric (GE) Digital's Predix platform. The UI platform may be framework agnostic. The platform provides functions, capabilities, and a default set of components that may be used with other frameworks, without a framework (or just the DOM framework itself). The UI platform may also be used to construct frameworks. The UI platform may be analogized to a bunch of Legos and building blocks that are used to build bigger and bigger components. For example, in user interface (e.g., web) application and system design, the building blocks are pieces that may be assembled together into pages, applications, multiple applications, and eventually an entire system.

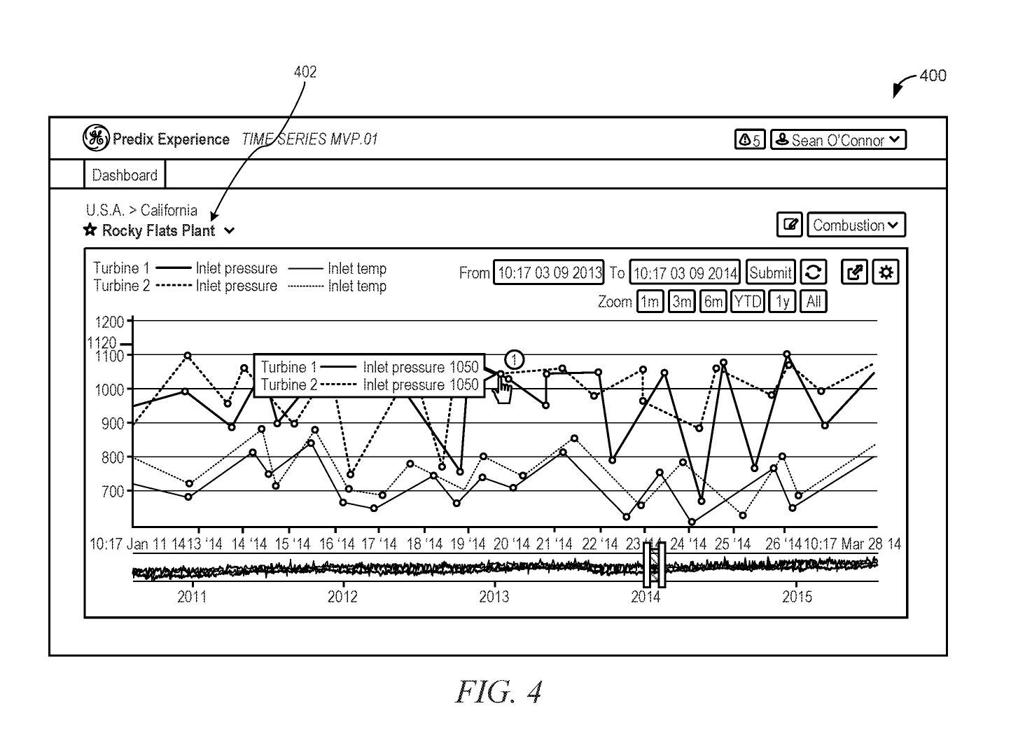

An industrial asset browser component may be one of a set of higher-order components that has been built from different pieces. In various embodiments, the asset browser component may be included as one of a plurality of components included in a “card” (described in more detail below) for selection of one or more assets that is active on the card. An example card may be a dashboard user interface that presents data pertaining to selected or active industrial assets in a time series data component (see, e.g., FIG. 4). In various embodiments, a higher-order application component in which the user interface component is included may be configured (e.g., programmatically, via an API) to make the selected industrial assets active within the user interface.

In various embodiments, the component is programmatically accessible and configurable by higher-order components. In various embodiments, all aspects of the component, such as colors used, fonts used, thickness of lines used, and so on, are user or programmatically (developer) configurable. In various embodiments, the aspects of the component are automatically adjusted programmatically based on a context of the user, as described in more detail below. For example, if the user moves into a darker environment, the component may be programmed to automatically become brighter. Or, if the user moves to a different location, the asset browser may change a breadcrumb to reflect a hierarchy of industrial assets that are proximate to the user's new location.

An asset browsing component may be included in a card. In various embodiments, a card is another higher-order component that represents a self-contained unit of work within an application or workflow. In various embodiments, a user may interact with cards, which together form a user interface experience, and there is a purpose associated with each card. For example, in an email application, an inbox user interface may be implemented on a first card and a details section corresponding to an individual selected email may be implemented on another card. The cards are tied together in a workflow that may be saved by the user, capturing a snapshot in time. The saved state may be shared with other users, but presented in a different manner to each user based on each user's context. Users may be alerted that some data cannot be presented to them based on their security level. In other cases, the user may not be notified that some data is not being presented to the user, such that the end user does not even know that the other data is there.

In example embodiments, a card may comprise part of a dashboard for managing industrial assets, such as a card that includes a time series data component to plot data items pertaining to active industrial assets and an asset browser component for selecting assets that are active in the dashboard. A set of cards may be included in a deck. Decks may have a common user interface theme, logic, or be part of a larger workflow module. In various embodiments, decks are stored as a higher-order component. A deck may have many cards; a card may belong to many decks; hence, decks and cards may have a many-to-many relationship. Depending on the context, a user may not be able to see every card or visualize all cards in the same manner as other users. Thus, a deck may be context-aware, context-sensitive, and context-adaptive. In various embodiments, multiple decks can be grouped together to create views. And many views can be grouped together to create a page.

As an example, an analyst may look at multiple (e.g., 10 sets) of time series data overlaid in various ways. An anomaly may be detected based on the analytics performed. The analyst (e.g., working in an “analyst” or “reporting” context) may then annotate the sets of time series data and save a snapshot for inclusion as an attachment to a case (e.g., for reporting purposes). The viewer of the report (e.g., working in a “viewer” or “decision-making” context) may not be interested in data other than the particular overlay showing the anomaly. Thus, when presented with the snapshot saved by the analyst, the time series data component may not present all of the multiple overlays used by the analyst to discover the anomaly. Instead, if the viewer is a decision maker, for example, the specific overlay(s) used to discover the anomaly may be highlighted or a smoothing of an aggregation of the multiple sets of time series data may be presented. Or, if the viewer is a field engineer (e.g., working in a “field” context), data pertaining to monitoring of the asset (e.g., time and place of likely reoccurrence) may be presented. In example embodiments, when a user requests an asset, they are also requesting the context of that asset (which in turn gets combined with the user's context to form a global context for an application). This global context is used by the platform and end application in an adaptive and responsive way. The application will “transform” according to the currently selected context or contexts. As an example, a user browses for Asset A with Context AC. The user has a general user context UC. The application responds to this by showing only cards that available for Asset A and Context AC-intersected-with-UC. A card may have visualization components inside of it that allow User U to work with Asset A and analyze its data. The visualization components may present different ways of visualizing an asset hierarchy, including Miller columns or graph-like visualizations (e.g., for multi-relationship asset-visualization that does not neatly fall into a hierarchy). In example embodiments, visual cues (e.g., icons) are used to classify assets (e.g., by type), making it easier for a user to quickly scan the hierarchy for relevant information. Given user context UC, the user may only have access to certain data stream or certain parts of the asset tree, and will therefore only see the parts that they have access to.

As an example, on startup of a wind turbine, there is an expected startup curve (e.g., with respect to various parameters, such as temperature or vibration). An analysis of the time series data may include taking overlays of recent (e.g., the most recent 20) startups of a single asset or of multiple similar assets, thus placing more value on data from more recent startups. If an analysis of the time series data shows there is a statistical deviation (e.g., with respect to vibration) for a particular asset, the time series data component may then present a notification of a detection, based on threshold settings, of an anomaly pertaining to an asset. The alert may be presented (or not) in the user interface depending on developer customizable settings. A presentation a snapshot of the anomaly in the time series component included in a user interface of an application executing on a device of a field engineer may provide specific information pertaining to the asset and a marker in the time series data showing the anomaly (e.g., a spike in vibration). The field engineer would then have helpful information to monitor and troubleshoot the asset. For example, the field engineer could restart the asset and troubleshoot the asset, focusing at the identified point in time of the anomaly. The data may be viewed in real-time by the field engineer and a control center analyst at the same time, each working in different contexts and thus being presented with different, context-optimized views of the same data. An annotation stream from the field engineer may be synchronized with event data and other metadata for viewing along with the corresponding time series data at the control center. In example embodiments, a set of industrial assets within a geographical range from the field engineer may be populated in the industrial asset browser component such that the field engineer may easily navigate to information pertaining to the industrial assets within a user interface presented on a device. In example embodiments, the industrial asset browser component may allow a user to rank or filter results using a context of the user, such as the GPS location of the user relative to the industrial assets or information pertaining to one or more work tasks that the user is assigned pertaining to the industrial assets (e.g., startup, shutdown, maintenance, reporting, and so on), as a starting point for navigation of a tree (or hierarchy) of available industrial assets.

Thus, in example embodiments, a context of the user is identified. For example, it is determined whether the user is a field engineer, a data analyst, a control center operator, or a decision-maker. For example, the context may include a profile of the user, information pertaining to the environment in which the user is working, including a location of the user, a device of the user (e.g., including device type, information pertaining to displays connected to the device), and so on. The context may include information gathered from a sensor of a device of the user, such as audio and visual conditions, such as levels of ambient noise, lighting conditions, whether the user is in motion, and so on. The context may include a purpose of the user in viewing the information. For example, if the user is a field engineer, the purpose of the user may be to monitor an asset in the field with respect to an anomaly that was detected in the control center. Based on the context, the way in which the time series data is presented and the ways in which the user may interact with the data is customized

Each of the components may register with the card and receive information from the card concerning other components. The components may communicate various ways in which the presentation of their data has changed to the other components, and the other components may be notified of and respond to the changes. For example, upon an updating of a selection of active industrial assets by a user using the asset browser component, other components, such as a time series data component, may be refreshed to present data related to the newly selected active set of industrial assets. A main communication component may be integrated with an adapter component in the card or deck level to provide the communication separate from the component. The components may leverage the web DOM/browser as the UI framework, thus keeping the framework agnostic of any specific implementation, such as JavaScript frameworks like Angular, Knockout, and Ember. As an example, each DOM component in HTML, such as TABLE or a DIV element, may have an associated Polymer element.

In various embodiments, a set of assets is accessible through the IIoT. The sensor data is received at a high-order level, such as the deck, which then communicates to children, such as cards or components on the cards. Adapters incorporated into the cards may then be connected to the time series data sources. There may be data stored in different formats by different assets. The format may be transformed by adapters into a common data format by modular components, added as needed by a developer of an application using the user interface platform. In other words, an adapter specific to an asset may be included on a card as needed.

Components may be context aware and context adaptive. For example, the asset browser component may automatically adapt to a user situation in the field, on the factory floor, or at home. The differences may be as subtle as the fonts or lines of user interface elements needing to be thicker or bolder for display in a large monitor in a factory environment than they are when they are displayed on a mobile device to a field engineer. As an example, the asset browser component may automatically update a breadcrumb for assets that are nearest a location of a device on which the asset browser component is executing such that a field engineer may more quickly navigate the asset hierarchy to find a particular nearby asset more quickly. In various embodiments, the breadcrumb may comprise a hint (e.g., a partial path) pertaining to the location of the currently selected asset within the hierarchy.

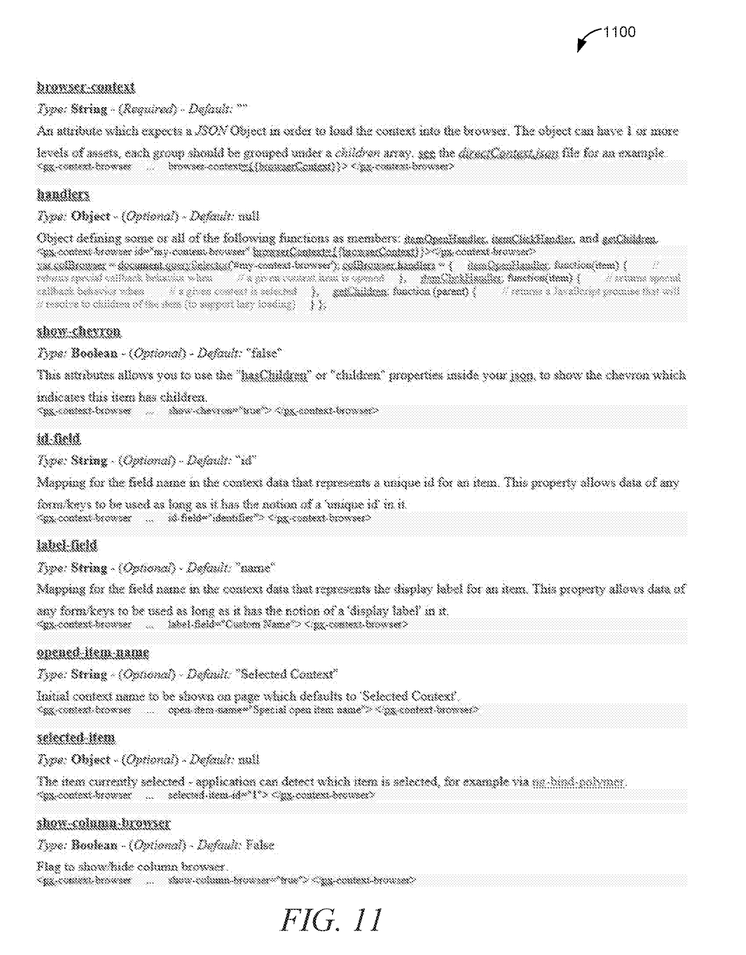

In various embodiments, an API exposes attributes of the asset browser component for programming The API may define various elements, such as JavaScript Object Notation (JSON) elements, for language independent data interchange of objects comprising attribute-value pairs. An example of such an API is shown in FIG. 11.

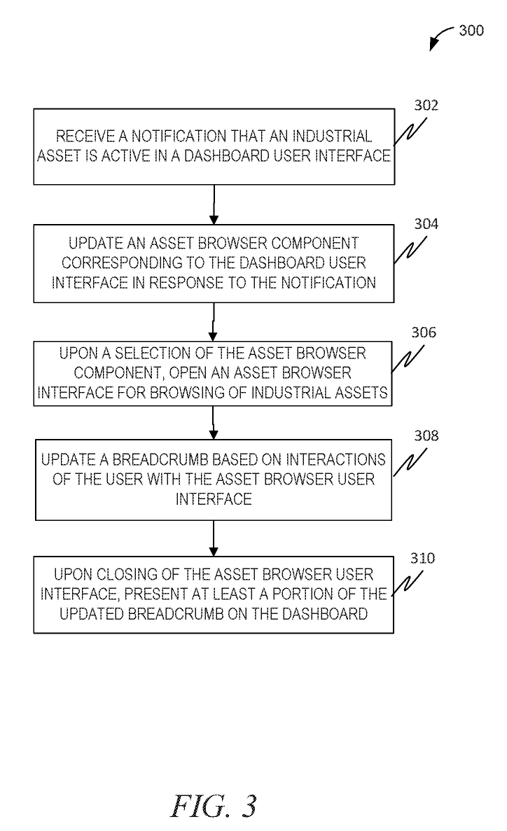

FIG. 3 is an example method 300 of implementing an industrial asset browser component in an application. In various embodiments, the industrial browser component is implemented in an application executing on a client device that is in communication with the asset browsing service 120 of FIG. 1.

At operation 302, a notification is received at an asset browser component embedded in a user interface of a change pertaining to assets that are active or likely soon to be active in a user interface with which the browser component is associated (e.g., such as the dashboard user interface described above). For example, the asset browser component may receive a notification that a new asset has been made active in the user interface, the new asset being in a different location in the asset hierarchy than other assets that are currently active. Or the asset browser component may receive a notification that a location of the user has changed such that particular assets in the hierarchy are now closer to the user than assets that are currently active in the user interface.

At operation 304, the asset browser component is updated with information relevant to the change. For example, the asset browser component may receive communications including a direct context from which the new asset is likely to be selected, or the asset browser may receive communications including an initial context of the asset that is likely to be selected, as described in more detail below. Based on the context information, the browser component may load information pertaining to navigation of the assets in the hierarchy, such as information pertaining to the names of the assets, the location of the assets, whether the assets have children, and whether each of the assets can be opened (or made active) within the dashboard user interface.

At operation 306, upon a selection of the asset browser component, an asset browser user interface is opened to allow the user to browse industrial assets. Example interfaces for various devices are depicted in FIGS. 4-8.

At operation 308, a breadcrumb is updated based on interactions of the user with the asset browser user interface. For example, based on a selection of an asset from the asset hierarchy, a breadcrumb is updated to show the user a navigation path to the parent, grandparent, and so on of one or more of the active assets, showing a path from the assets up to the root of a hierarchical asset tree. In various embodiments, the hierarchy is provided by the asset browsing service 120.

At operation 310, upon a closing of the asset browser user interface, at least a portion of the updated breadcrumb is presented in the dashboard user interface. For example, a title of the asset browser component is updated to include at least some of the path of breadcrumbs that were updated at operation 308.

FIG. 4 is a line drawing depicting an example user interface 400 of a dashboard card of an application executing on a device of a user. Reference numeral 402 corresponds to an asset browser component that is associated with a time series data component, both of which are included on the card. The title of the dashboard component includes a currently selected turbine plant (“Rocky Flats Plant”) for which data is being presented in the time series data component. The title of the dashboard component also includes a breadcrumb pertaining to the selection of the turbine plant (“U.S.A.>California”). A selection of the title will bring up the asset browser user interface for modifying a selection of one or more assets that is to be presented in the time series data component. Upon closing of the asset browser user interface, the breadcrumb may be updated to reflect any changes to the selection of active assets in the dashboard. Alternatively, even if there is not a change to the active assets, the breadcrumb or title of the component may change to reflect likely candidates for selection, such as candidate assets that are nearest to the user's location. In various embodiments, the title may reflect the nearest asset and be clickable by the user to make the nearest asset active without opening the full asset browser user interface.

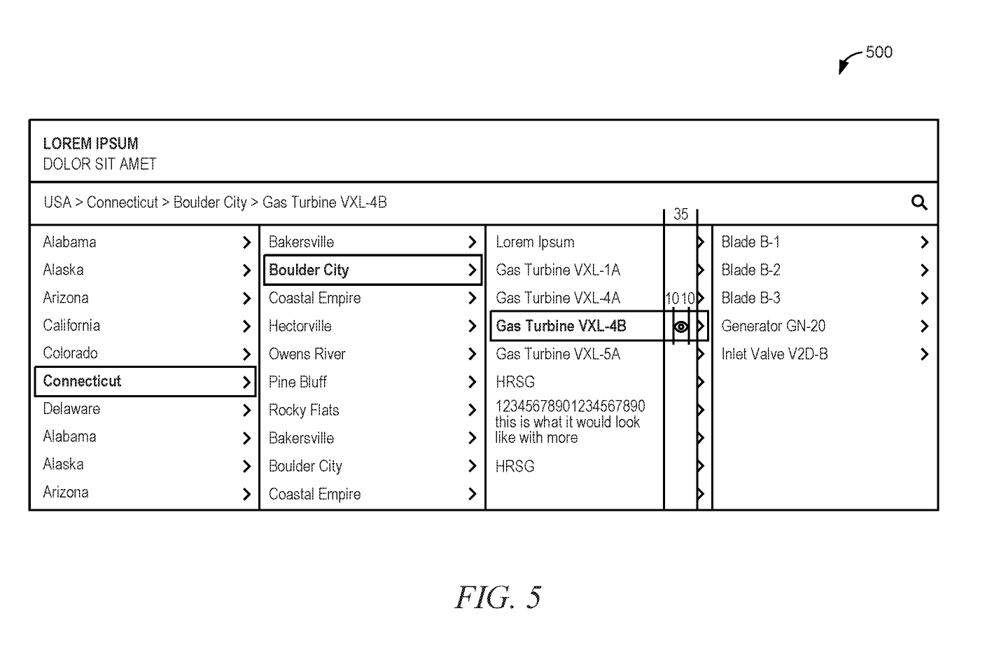

FIG. 5 is a line drawing depicting an example user interface 500 of an asset browser user interface suitable for presentation on a wide display, such as a tablet or personal computer display. In this example, the user has drilled down to a particular asset (“Gas Turbine VXL-4B”), leaving a breadcrumb trail (“USA>Connecticut>Boulder City>Gas Turbine VXL-4B). The asset has five children, including Blade B-1, Blade B-2, Blade B-3, Generator GN-20, and Inlet Valve V2D-B, each of which is associated with additional children (as evidenced by the “>” indicator). An indicator (“eye” icon) shows that this asset is a currently selected asset in the dashboard user interface.

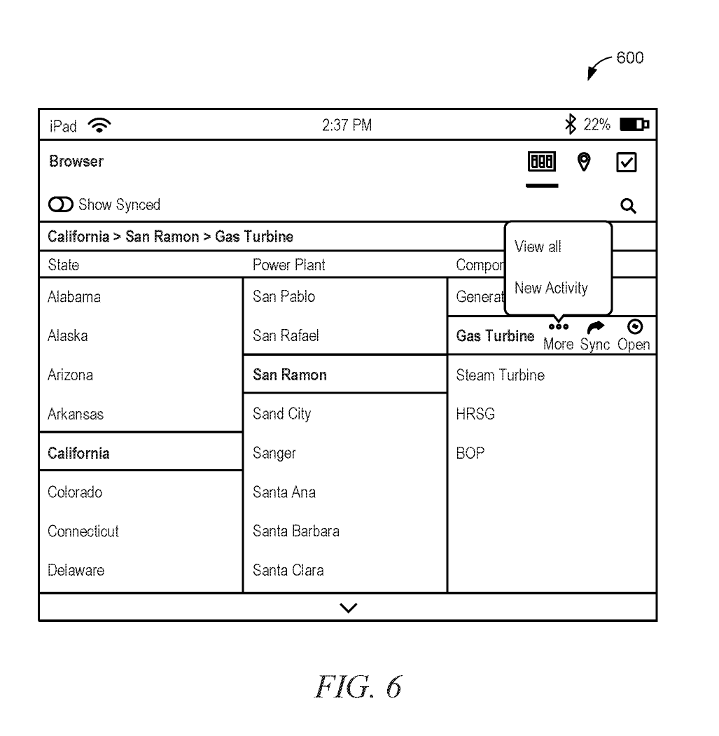

FIG. 6 is a line drawing depicting an example user interface 600 of an additional asset browser user interface. In this example, the user has drilled down to a particular asset (“Gas Turbine”), leaving a breadcrumb trail (“California>San Ramon>Gas Turbine”). Indicators are provided showing that the selected asset can be opened in the dashboard, synchronized with the dashboard, or viewed according to activities (new or all) associated with the asset.

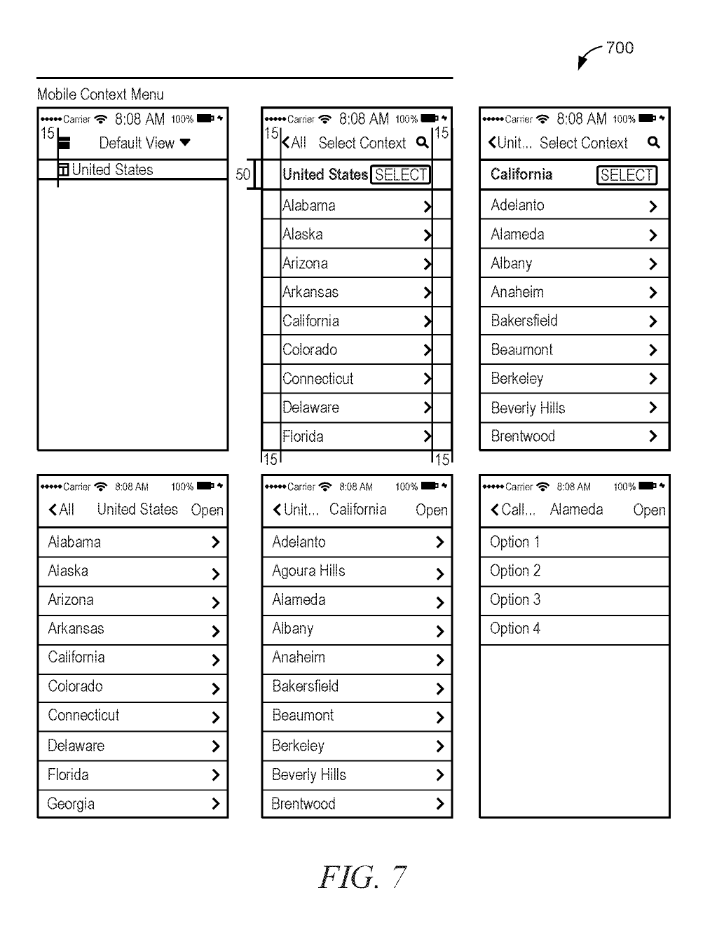

FIG. 7 is a line drawing depicting an example user interface 700 of an additional asset browser user interface that is suitable for presentation on a mobile device. This example shows progressive user interface screens being presented upon selection of options going from the root default view (“United States”) to “California” to “Alameda.” From there, the user can select from various options (e.g., corresponding to assets at the location).

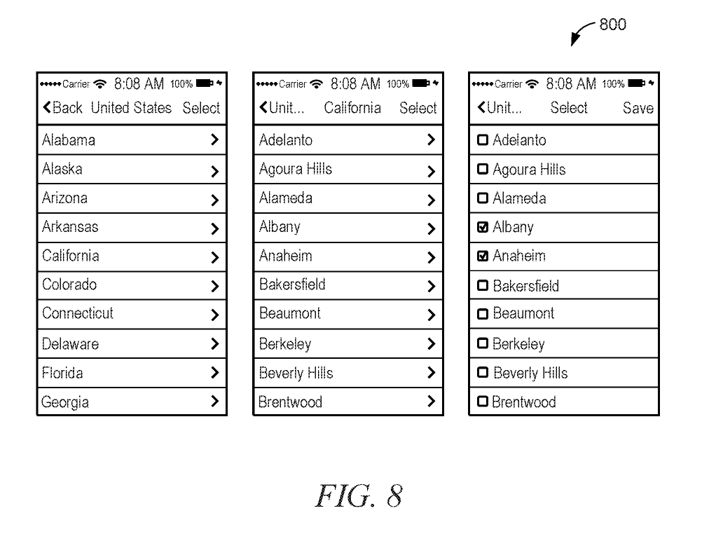

FIG. 8 is a line drawing depicting an example user interface 800 of an additional asset browser user interface that is suitable for presentation on a mobile device. This example shows progressive user interface screens being presented upon selection of options going from the root default view (“United States”) to “California.” From there, the user can select multiple regions to trigger display of assets in the multiple selected regions.

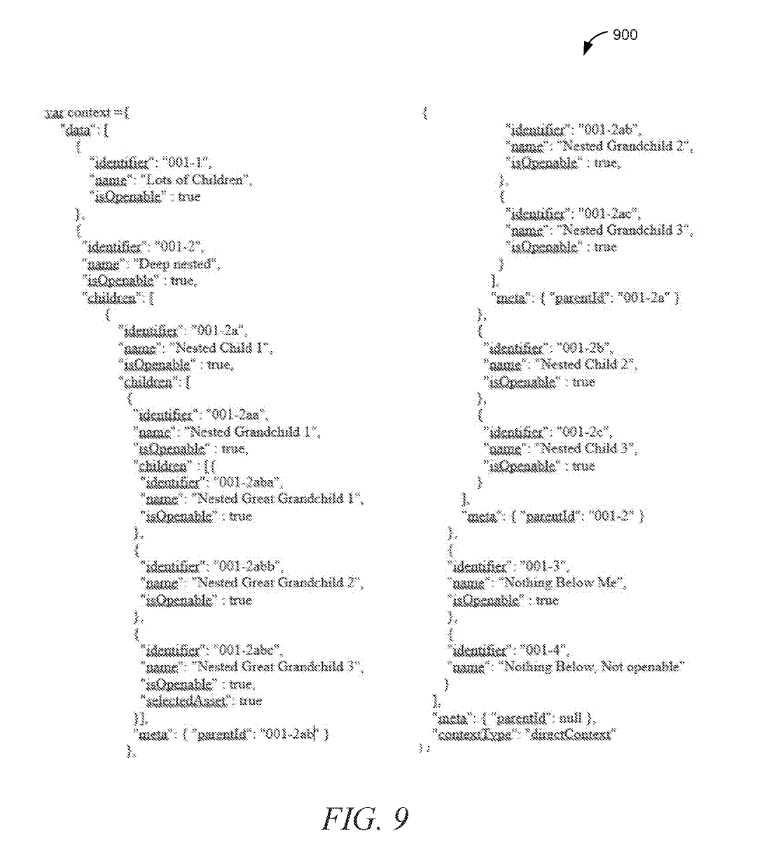

FIG. 9 is an example of a direct context 900 that may be received via an API of the asset browser component (e.g., from the asset browsing service 120) or from other components or programming logic included in a card containing the asset browser component. The direct context data provides that asset browser with just enough information to present data in a first set of columns (e.g., one or two columns) of the asset browser user interface. The API includes “selectedasset,” which is a Boolean value that denotes whether this item is the one that should be loaded as the context, and “children,” which is an array containing the children of the item. The “children” value is included only along the path of the selected item and not on each and every item.

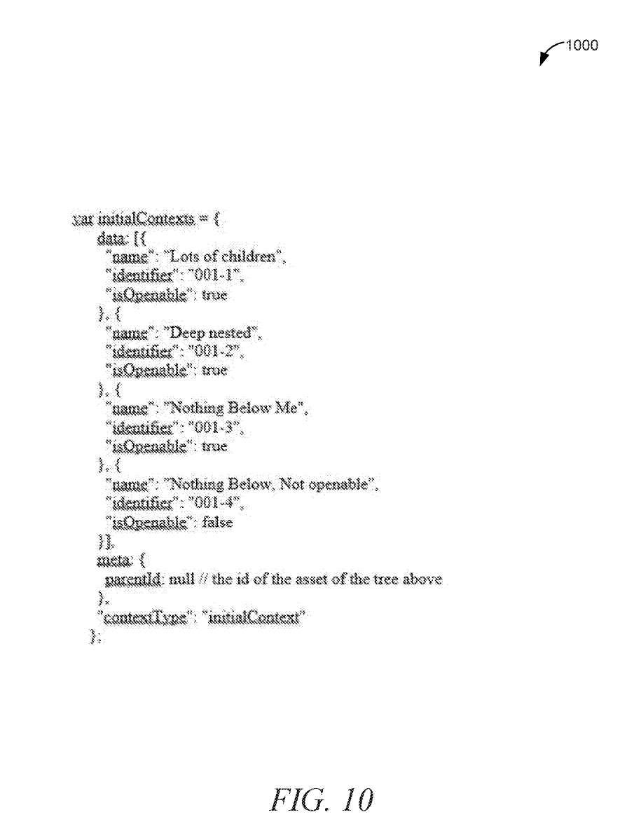

FIG. 10 is an example of an initial context 1000 that may be received via an API of the asset browser in the same way as described above with respect to FIG. 9. The initial context 1000 may include a subset of the direct context 900, but it may nevertheless be used by the asset browser component to populate the asset browser user interface. Thus, the asset browser component may be eventually populated (e.g., through refreshing of the menu items as the user navigates through assets in the asset browser user interface and/or communications between the component and the asset browsing service 120) despite not having a complete context initially. For example, a user can start off (e.g., in the Asset Browser) in a position of the asset hierarchy as if they had already drilled-down to that specific asset. In this case, the user may see a direct line up the hierarchy, but may not have full visibility of the asset elements at higher points in the hierarchy. In example embodiments, the user would have this full visibility only if the user had drilled down through the assets from a higher point in the hierarchy.

FIG. 11 is an example API 1100 for programmatically-accessing or controlling an asset browser component that is included in a user interface. The attributes include a browser-context (a browser-specific context that is separate from the user context discussed above), handlers, show-chevron, id-field, label-field, opened-item-name, selected-item, and show-column-browser. In this way a user interface developer may be able to customize the behaviour of the asset browser component (e.g., to fit a purpose of a user interface card). In example embodiments, each node in the asset hierarchy may have detailed information about the physical asset it represents. By selecting a node, the user may be able to perform an action (e.g., an “open” action) to see details about the asset. In example embodiments, the asset browser component includes asset-specific extensions to support asset-specific displays of specific details corresponding to specific assets in response to the user requesting the asset-specific display by performing a corresponding action via a node in the hierarchy.

The following examples are non-limiting examples of example embodiments of the subject matter disclosed herein.

### EXAMPLE 1

In example embodiments, a system is disclosed that comprises an instance of a user interface component corresponding to a dashboard user interface. The instance of the user interface component configures one or more processors of a device to present data pertaining to a current industrial asset selected from an industrial internet of things (IIoT). The system also comprises an instance of an asset browser component that configures the one or more processors of the device to present a hint pertaining to a location of the current industrial asset within a hierarchical tree representing the IIoT and present a user interface to facilitate selection of a new industrial asset from the IIoT. The instance of the asset browser component is communicatively coupled to the instance of the user interface component such that the selection of the new industrial asset from the IIoT causes the instance of the user interface component to present data pertaining to the new industrial asset.

### EXAMPLE 2

In example embodiments, the instance of the asset browser component in the system of Example 1 further configures the one or more processors of the device to update the hint pertaining to the location of the current industrial asset based on the selection of the new industrial asset from the IIoT.

### EXAMPLE 3

In example embodiments, in the system of Example 1 or Example 2, the instance of the user interface component configures the one or more processors of the device to select a different asset as the current industrial asset based on a change to a context associated with the IIoT and wherein the instance of the asset browser component configures the one or more processors of the device to receive a notification of the selecting of the different asset and, based on the notification, update the hint based on the selecting of the different asset.

### EXAMPLE 4

In example embodiments, in the system of Example 3, the context is a global context that includes a combination of a context of the different asset and a context of a user of the device.

### EXAMPLE 5

In example embodiments, in the system of Example 1, 2, 3, or 4, the user interface includes navigable user interface elements corresponding to a portion of the hierarchical tree, the portion selected based on the location and a context of a user of the device.

### EXAMPLE 6

In example embodiments, in the system of Example 1, 2, 3, 4, or 5, the instance of the user interface component configures the one or more processors of the device to receive a notification of the selection of the new industrial asset and, based on the notification, present data pertaining to the new industrial asset on the dashboard user interface.

### EXAMPLE 7

In example embodiments, in the system of Example 1, 2, 3, 4, 5, or 6, the user interface is prepopulated based on a geographical location of a user of the device relative to geographical locations of industrial assets in the IIoT.

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an application specific integrated circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

The modules, methods, applications, and so forth described herein are implemented, in some embodiments, in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

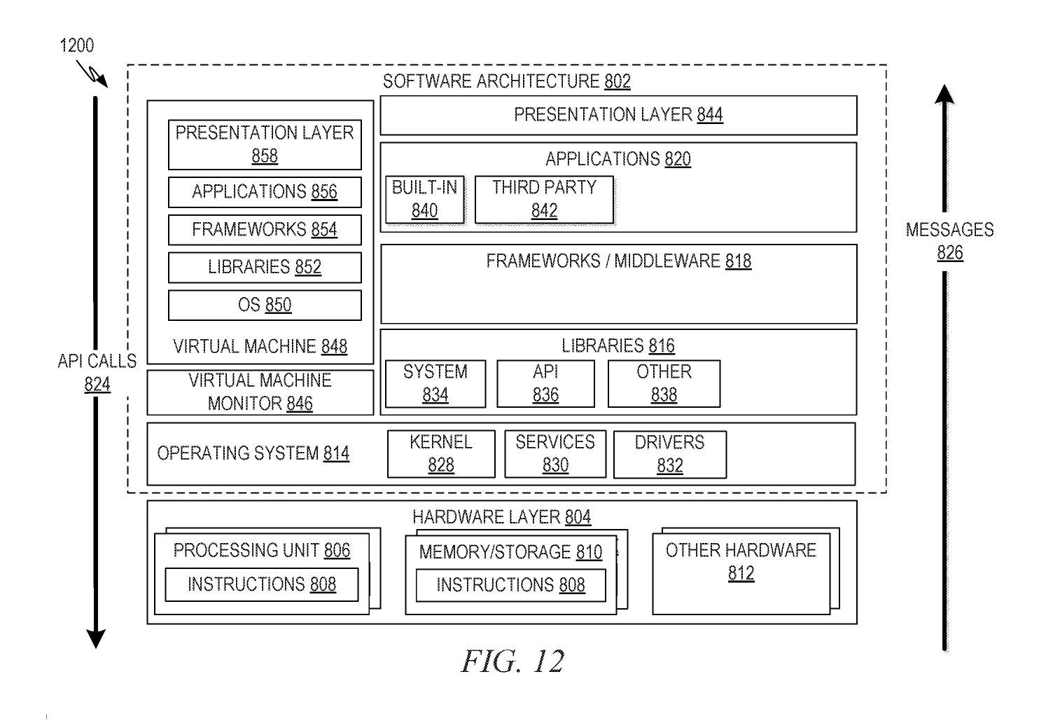

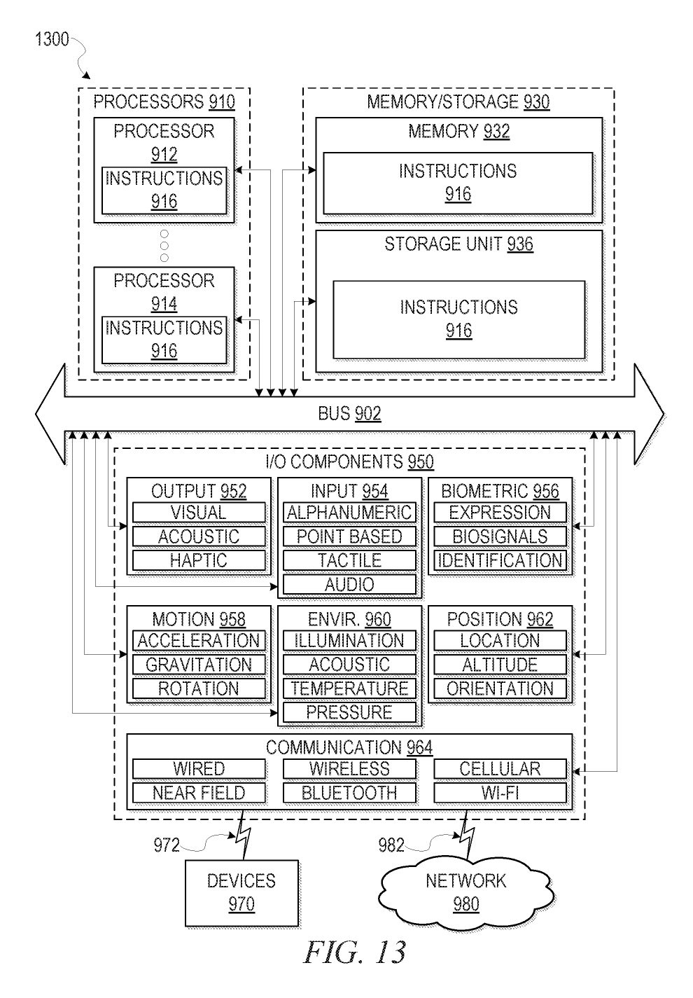

FIG. 12 is a block diagram 1200 illustrating a representative software architecture 802, which may be used in conjunction with various hardware architectures herein described. FIG. 12 is merely a non-limiting example of a software architecture 802, and it will be appreciated that many other architectures may be implemented to facilitate the functionality described herein. The software architecture 802 may be executing on hardware such as a machine 1300 of FIG. 13 that includes, among other things, processors 910, memory/storage 930, and I/O components 950. A representative hardware layer 804 is illustrated and can represent, for example, the machine 1300 of FIG. 13. The representative hardware layer 804 comprises one or more processing units 806 having associated executable instructions 808. The executable instructions 808 represent the executable instructions of the software architecture 802, including implementation of the methods, modules, and so forth described herein. The hardware layer 804 also includes memory and/or storage modules 810, which also have the executable instructions 808. The hardware layer 804 may also comprise other hardware 812, which represents any other hardware of the hardware layer 804, such as the other hardware illustrated as part of the machine 1300.

In the example architecture of FIG. 12, the software architecture 802 may be conceptualized as a stack of layers where each layer provides particular functionality For example, the software architecture 802 may include layers such as an operating system 814, libraries 816, frameworks/middleware 818, applications 820, and a presentation layer 844. Operationally, the applications 820 and/or other components within the layers may invoke API calls 824 through the software stack and receive a response, returned values, and so forth illustrated as messages 826 in response to the API calls 824. The layers illustrated are representative in nature, and not all software architectures have all layers. For example, some mobile or special purpose operating systems may not provide a frameworks/middleware 818, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 816 may provide a common infrastructure that may be utilized by the applications 820 and/or other components and/or layers. The libraries 816 typically provide functionality that allows other software modules to perform tasks in an easier fashion than to interface directly with the underlying operating system 814 functionality (e.g., kernel 828, services 830, and/or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D in a graphic context on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks/middleware 818 may provide a higher-level common infrastructure that may be utilized by the applications 820 and/or other software components/modules. For example, the frameworks/middleware 818 may provide various graphic user interface (GUI) functions, high-level resource management, high-level location services, and so forth. The frameworks/middleware 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a contacts application, a browser application, a book reader application, a location application, a media application, a messaging application, and/or a game application. Third-party applications 842 may include any of the built-in applications 840 as well as a broad assortment of other applications. In a specific example, the third-party application 842 (e.g., an application developed using the Android™ or iOS™ software development kit (SDK) by an entity other than the vendor of the particular platform) may be mobile software running on a mobile operating system such as iOS™ Android™, Windows® Phone, or other mobile operating systems. In this example, the third-party application 842 may invoke the API calls 824 provided by the mobile operating system such as the operating system 814 to facilitate functionality described herein.

The applications 820 may utilize built-in operating system functions (e.g., kernel 828, services 830, and/or drivers 832), libraries (e.g., system libraries 834, API libraries 836, and other libraries 838), and frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with a user.

Some software architectures utilize virtual machines. In the example of FIG. 12, this is illustrated by a virtual machine 848. A virtual machine creates a software environment where applications/modules can execute as if they were executing on a hardware machine (such as the machine 1300 of FIG. 13, for example). The virtual machine 848 is hosted by a host operating system (operating system 814 in FIG. 12) and typically, although not always, has a virtual machine monitor 846, which manages the operation of the virtual machine 848 as well as the interface with the host operating system (i.e., operating system 814). A software architecture executes within the virtual machine 848, such as an operating system 850, libraries 852, frameworks/middleware 854, applications 856, and/or a presentation layer 858. These layers of software architecture executing within the virtual machine 848 can be the same as corresponding layers previously described or may be different.

FIG. 13 is a block diagram illustrating components of a machine 1300, according to some example embodiments, able to read instructions 916 from a machine-readable medium (e.g., a machine-readable storage medium) and perform any one or more of the methodologies discussed herein. Specifically, FIG. 13 shows a diagrammatic representation of the machine 1300 in the example form of a computer system, within which the instructions 916 (e.g., software, a program, an application, an applet, an app, or other executable code) for causing the machine 1300 to perform any one or more of the methodologies discussed herein may be executed. For example, the instructions 916 may cause the machine 1300 to execute the flow diagram of FIG. 3. Additionally, or alternatively, the instructions 916 may implement modules of FIG. 1, and so forth. The instructions 916 transform the general, non-programmed machine 1300 into a particular machine programmed to carry out the described and illustrated functions in the manner described. In alternative embodiments, the machine 1300 operates as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 1300. Further, while only a single machine 1300 is illustrated, the term “machine” shall also be taken to include a collection of machines 1300 that individually or jointly execute the instructions 916 to perform any one or more of the methodologies discussed herein.

The machine 1300 may include processors 910, memory/storage 930, and I/O components 950, which may be configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), another processor, or any suitable combination thereof) may include, for example, a processor 912 and a processor 914 that may execute the instructions 916. The term “processor” is intended to include a multi-core processor 912, 914 that may comprise two or more independent processors 912, 914 (sometimes referred to as “cores”) that may execute the instructions 916 contemporaneously. Although FIG. 13 shows multiple processors 910, the machine 1300 may include a single processor 912, 914 with a single core, a single processor 912, 914 with multiple cores (e.g., a multi-core processor 912, 914), multiple processors 912, 914 with a single core, multiple processors 912, 914 with multiples cores, or any combination thereof.

The memory/storage 930 may include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 may also reside, completely or partially, within the memory 932, within the storage unit 936, within at least one of the processors 910 (e.g., within the cache memory of processor 912, 914), or any suitable combination thereof, during execution thereof by the machine 1300. Accordingly, the memory 932, the storage unit 936, and the memory of the processors 910 are examples of machine-readable media.

As used herein, “machine-readable medium” means a device able to store the instructions 916 and data temporarily or permanently and may include, but not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 1300), such that the instructions 916, when executed by one or more processors of the machine 1300 (e.g., processors 910), cause the machine 1300 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 may include a wide variety of components to receive input, provide output, produce output, transmit information, exchange information, capture measurements, and so on. The specific I/O components 950 that are included in a particular machine 1300 will depend on the type of machine 1300. For example, portable machines such as mobile phones will likely include a touch input device or other such input mechanisms, while a headless server machine will likely not include such a touch input device. It will be appreciated that the I/O components 950 may include many other components that are not shown in FIG. 13. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 1300 to a network 980 or devices 970 via a coupling 982 and a coupling 972 respectively. For example, the communication components 964 may include a network interface component or other suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

In various example embodiments, one or more portions of the network 980 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., hypertext transfer protocol (HTTP)). Similarly, the instructions 916 may be transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine , and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
an instance of a user interface component corresponding to a dashboard user interface, the instance of the user interface component configuring one or more processors of a device to present data pertaining to a current industrial asset selected from an industrial internet of things (IIoT); and
an instance of an asset browser component, the instance of the asset browser component configuring the one or more processors of the device to present a hint pertaining to a location of the current industrial asset within a hierarchical tree representing the IIoT and presenting a user interface to facilitate selection of a new industrial asset from the IIoT, the instance of the asset browser component communicatively coupled to the instance of the user interface component such that the selection of the new industrial asset from the IIoT causes the instance of the user interface component to present data pertaining to the new industrial asset.

2. The system of claim 1, wherein the instance of the asset browser component further configures the one or more processors of the device to update the hint pertaining to the location of the current industrial asset based on the selection of the new industrial asset from the IIoT.

3. The system of claim 1, wherein the instance of the user interface component configures the one or more processors of the device to select a different asset as the current industrial asset based on a change to a context associated with the IIoT and wherein the instance of the asset browser component configures the one or more processors of the device to receive a notification of the selecting of the different asset and, based on the notification, update the hint based on the selecting of the different asset.

4. The system of claim 3, wherein the context is a global context that includes a combination of a context of the different asset and a context of a user of the device.

5. The system of claim 1, wherein the user interface includes navigable user interface elements corresponding to a portion of the hierarchical tree, the portion selected based on the location and a context of a user of the device.

6. The system of claim 1, wherein the instance of the user interface component configures the one or more processors of the device to receive a notification of the selection of the new industrial asset and, based on the notification, present data pertaining to the new industrial asset on the dashboard user interface.

7. The system of claim 1, wherein the user interface is prepopulated based on a geographical location of a user of the device relative to geographical locations of industrial assets in the IIoT.

8. A method comprising:
at a device communicatively coupled to one or more services corresponding to an industrial internet of things (IIoT), using an instance of a user interface component corresponding to a dashboard user interface to present data pertaining to a current industrial asset selected from the IIoT; and
using an instance of an asset browser component to present a hint pertaining to a location of the current industrial asset within a hierarchical tree representing the IIoT and presenting a user interface to facilitate selection of a new industrial asset from the IIoT, the instance of the asset browser component communicatively coupled to the instance of the user interface component such that the selection of the new industrial asset from the IIoT causes the instance of the user interface component to present data pertaining to the new industrial asset.

9. The method of claim 8, further comprising using the asset browser component to update the hint pertaining to the location of the current industrial asset based on the selection of the new industrial asset from the IIoT.

10. The method of claim 8, further comprising using the instance of the user interface component to select a different asset as the current industrial asset based on a change to a context associated with the IIoT and using the instance of the asset browser component to receive a notification of the selecting of the different asset and, based on the notification, updating the hint based on the selecting of the different asset.

11. The method of claim 10, wherein the context is a global context that includes a combination of a context of the different asset and a context of a user of the device.

12. The method of claim 8, wherein the user interface includes navigable user interface elements corresponding to a portion of the hierarchical tree, the portion selected based on the location and a context of a user of the device.

13. The method of claim 8, further comprising using the user interface component to receive a notification of the selection of the new industrial asset and, based on the notification, presenting data pertaining to the new industrial asset on the dashboard user interface.

14. The method of claim 8, wherein the user interface is prepopulated based on a geographical location of a user of the device relative to geographical locations of industrial assets in the IIoT.

15. A non-transitory machine-readable storage medium storing a set of instructions that, when executed by at least one processor, causes the at least one processor to perform operations, the operations comprising:
using an instance of a user interface component corresponding to a dashboard user interface to present data pertaining to a current industrial asset selected from an industrial internet of things (IIoT); and
using an instance of an asset browser component to present a hint pertaining to a location of the current industrial asset within a hierarchical tree representing the IIoT and presenting a user interface to facilitate selection of a new industrial asset from the IIoT, the instance of the asset browser component communicatively coupled to the instance of the user interface component such that the selection of the new industrial asset from the IIoT causes the instance of the user interface component to present data pertaining to the new industrial asset.

16. The non-transitory machine-readable storage medium of claim 15, the operations further comprising using the asset browser component to update the hint pertaining to the location of the current industrial asset based on the selection of the new industrial asset from the IIoT.

17. The non-transitory machine-readable storage medium of claim 15, the operations further comprising using the instance of the user interface component to select a different asset as the current industrial asset based on a change to a context associated with the IIoT and using the instance of the asset browser component to receive a notification of the selecting of the different asset and, based on the notification, updating the hint based on the selecting of the different asset.

18. The non-transitory machine-readable storage medium of claim 17, wherein the context is a global context that includes a combination of a context of the different industrial asset and a context of a user of a device.

19. The non-transitory machine-readable storage medium of claim 18, wherein the user interface includes navigable user interface elements corresponding to a portion of the hierarchical tree, the portion selected based on the location and the context of the user of the device.

20. The non-transitory machine-readable storage medium of claim 15, the operations further comprising using the user interface component to receive a notification of the selection of the new industrial asset and, based on the notification, presenting data pertaining to the new industrial asset on the dashboard user interface.
